(19) United States
(12) Patent Application Publication
(10) Pub. No.: US 2026/0085998 A1
(43) Pub. Date: Mar. 26, 2026

(54) FREE SPACE OPTICAL SPECTROMETER SYSTEMS AND METHODS FOR THEIR USE

(71) Applicant: JP3 Measurement, LLC, Austin, TX (US)

(72) Inventors: Jie Zhu, Fulshear, TX (US); Joseph Paul Little, III, San Antonio, TX (US); Jordan Dwelle, Austin, TX (US); Ronald Austin Dove, Mount Airy, MD (US); Thomas Michael Redlinger, Houston, TX (US); William Henry Tsakopulos, JR., Austin, TX (US)

(73) Assignee: JP3 Measurement, LLC, Austin, TX (US)

(21) Appl. No.: 19/331,945

(22) Filed: Sep. 17, 2025

Related U.S. Application Data
(60) Provisional application No. 63/697,421, filed on Sep. 20, 2024.

(51) Int. Cl. G01M 15/02; G01M 15/10; G01N 21/3504

(52) U.S. Cl. CPC G01M 15/02; G01M 15/10; G01N 21/3504; G01N 2021/3509; G01N 2201/12746; G01N 2201/1293

(57) ABSTRACT

Free-space optical spectrometer systems and methods for their use, including in certain use cases related to the oil and gas industry are disclosed. In certain embodiments, the system includes a laser module configured to output a beam comprising an output spectrum along a free-space optical pathway, a flow cell positioned in the pathway and configured to contain a sample fluid through which the beam is transmitted, and a detector configured to receive the transmitted beam and convert optical characteristics into corresponding electrical signals. Processing circuitry may determine an experimental spectrum of the transmitted beam, which can be calibrated based on information obtained from reference spectra collected by the spectrometer system for increased accuracy. The disclosed systems and methods enable high-resolution, non-contact spectral analysis of fluids or gases with improved stability, compactness, and adaptability compared to conventional fiber-coupled systems.

### PRIORITY STATEMENT UNDER 35 U.S.C. § 119 & 37 C.F.R. § 1.78

This non-provisional application claims priority based upon prior U.S. Provisional Patent Application Ser. No. 63/697,421 filed Sep. 17, 2024, in the names of Jie Zhu, Joseph Paul Little, III, Jordan Dwelle, Ronald Austin Dove, Thomas Michael Redlinger, William Henry Tsakopulos, Jr., entitled “FREE SPACE OPTICAL SPECTROMETER SYSTEMS AND METHODS FOR THEIR USE” the disclosures of which are incorporated herein in their entirety by reference as if fully set forth herein.

### BACKGROUND OF THE INVENTION

This disclosure relates, generally, to spectrometers and spectroscopy, and specifically to spectrometers that use free-space optical paths for light propagation (referred to herein interchangeably as “FSO spectrometers”, or “FSO spectroscopy systems”) and the methods for their implementation in industrial applications, including those in the oil and gas industry.

Spectroscopy is a fundamental analytical technique widely used in various fields, including chemistry, physics, biology, and material science. Spectroscopy plays a critical role in a wide array of scientific and industrial applications, enabling the identification, analysis, and quantification of various substances through the study of light-matter interactions. It involves the interaction of electromagnetic radiation with matter to measure the intensity of light as a function of wavelength or frequency. The information obtained from this interaction allows for the identification and quantification of different substances, the study of molecular structures, and the investigation of dynamic processes.

Spectrometers (also referred to herein as “spectroscopy systems”) are devices that perform spectroscopy by dispersing light into its component wavelengths and measuring the resulting spectrum. These instruments have been employed for decades in both research and industrial settings to analyze gases, liquids, and solids.

Spectroscopy is a powerful tool that is useful in many industries, including but not limited to oil and gas. Spectroscopy is used to analyze core samples from reservoirs to determine the mineral composition, porosity, and fluid content. Techniques like Near-Infrared (NIR) spectroscopy help in identifying the types of hydrocarbons present and their quantities. Spectroscopic techniques like Fourier-transform infrared (FTIR) spectroscopy and Nuclear Magnetic Resonance (NMR) are used to characterize crude oil. This helps in determining its quality, sulfur content, and the presence of other impurities, which is crucial for refining processes. During refining, spectroscopy is used for real-time monitoring of various parameters such as the concentration of specific compounds, reaction rates, and the presence of contaminants.

In fact, spectroscopy may be helpful in many applications across the oil and gas industry. For example, spectroscopy may be employed to monitor emissions and effluents from oil and gas operations to detect and quantify pollutants, ensuring compliance with environmental regulations; they may be used to separate different products supplied to a location via a single supply line; to control bi-fuel engines; and to control chemical and physical processes through the production and refinement process.

In such applications within the oil and gas industry, spectrometers may need to be deployed in harsh or dangerous conditions, such in refineries, near the production site, and within high-pressure, high-temperature environments. These situations present several challenges, particularly when analyzing volatile materials.

The use of spectrometers in harsh or dangerous conditions, particularly for analyzing volatile materials, presents significant challenges related to safety, accuracy, and equipment reliability. Explosion-resistant enclosures offer a critical solution, enhancing safety, ensuring compliance with regulations, and improving the operational reliability and lifespan of the equipment. By addressing these challenges, the oil and gas industry can achieve more reliable, accurate, and safe spectroscopic analyses, leading to better decision-making and process optimization.

Volatile materials, such as hydrocarbons, can easily ignite or explode when exposed to an ignition source. Refineries involve processes like cracking and distillation that occur at high temperatures and pressures. The risk of explosion from these chemicals increases when they are at high temperatures and pressures. Spectrometers used to analyze these materials and operate in such environments must be robust enough to handle these extreme conditions without compromising accuracy and must do so safely.

In many of these industrial applications continuous, real-time monitoring is essential, requiring spectrometers that can operate independently and reliably over long periods without human intervention. Further, in some cases, spectrometers are used in remote, dangerous, or difficult-to-access locations, such as deep within pipelines or near drilling operations. Therefore, maintenance and calibration of these instruments can be challenging, necessitating robust, low-maintenance designs, and preferably ones that can be calibrated remotely.

Unfortunately, there are limitations to a traditional spectrometer's ability to accurately analyze materials under certain conditions. For example, for in-line monitoring of oil and gas lines, which involves placing a spectrometer proximate to the process stream, such as a fast loop, to continuously analyze the composition and properties of the fluid or gas being processed, often involve or create conditions which may hinder or prevent the accurate analysis of the in-line material by a traditional spectrometer.

In many oil and gas processes, temperatures can exceed the operational limits of spectrometers. High temperatures can damage sensitive optical and electrical components, affect the accuracy of the measurements, and lead to thermal drift, where the spectrometer's readings change due to temperature variations rather than actual changes in the sample.

Additional problems with traditional spectroscopy systems include that of fouling. Fouling occurs when solid particles, organic materials, or other contaminants in the process stream deposit on the optical windows or other components of the spectrometer. In processes where temperature changes occur, condensation of water or hydrocarbons can form on the optical windows of the spectrometer which can obscure the light path, leading to inaccurate or noisy spectral data. In oil and gas processes, this can include substances like asphaltenes, waxes, or scale, which can build up over time. Fouling reduces the clarity of the optical path, leading to scattering and attenuation of the light signal. This degrades the quality of the spectral data and can necessitate frequent cleaning or maintenance of the spectrometer, which interrupts continuous monitoring and increases operational costs. In some cases, fouling can involve corrosive substances that damage the optical components, further reducing the lifespan of the spectrometer and potentially leading to costly repairs or replacements.

Condensation can also introduce contaminants into the sample, further complicating the analysis. Further, condensates can scatter or absorb the light used in spectroscopy, leading to a reduction in signal strength and quality. This can result in poor signal-to-noise ratios, making it difficult to accurately identify and quantify the components of the material being monitored.

One category of spectrometers, known as free-space optical (“FSO”) spectrometers/spectroscopy systems, operate by allowing light to propagate through an unobstructed, free-space (i.e., air or a vacuum) without the need for waveguides or optical fibers. In FSO spectrometers, light from a source is typically collimated, dispersed, and then focused onto a detector or a detector array. These systems are advantageous due to their simplicity, reduced optical losses, and the ability to handle a wide range of wavelengths and light intensities. The free-space approach also facilitates the design of optical paths that are easily adjustable and can be configured to meet specific application requirements.

The FSO spectrometer systems of the present disclosure enable in-situ measurements within pipelines and pressurized containers. Further, embodiments for FSO spectrometers such as those contemplated hereby may be hardened such that they may operate in dangerous environments and while processing volatile materials and may be programmed to do so cyclically and automatically. This means that in many applications (including, but certainly not limited to many in the oil and gas production, processing, and distribution space) there is no need for changing from pipeline conditions in order to obtain an experimental result measuring from the FSO spectrometer system of what is flowing through the pipeline, in near real time.

Spectroscopy systems and other process instruments not utilizing such free-space architectures are often subject to the requirement of reducing the pressure and/or temperature of the test sample in order for it to be measured properly. Free-space optic spectrometers, such as those discussed herein may additionally provide for advantages over conventional spectrometer systems by being less subject to fouling, condensation, and additional issues that may occur when having to change the characteristics of the subject fluid from those in-situ (in pipeline).

Notwithstanding the other benefits provided by FSO spectrometers, they like most spectrometers often require frequent calibration to maintain accuracy, especially in applications like that of in-line analysis, where they face changing process conditions like temperature, pressure, and chemical composition. Additionally, spectrometers can drift over time due to environmental factors, further requiring regular recalibration or adjustment. Inconsistent calibration or drift can result in data inaccuracies, leading to incorrect process adjustments or suboptimal performance. In certain applications, like an in-line setup, calibration may be challenging and may require shutting down the process, leading to undesirable downtime. Accordingly, it may be beneficial for some FSO spectrometers to include a system that enables the spectrometer to be remotely and/or automatically calibrated.

### BRIEF SUMMARY OF THE INVENTION

The FSO architecture of the spectrometers described herein may operate without the use of expensive fiber optics, which can potentially improve the spectrometer's signal to noise ratio by reducing spectral noise that is typically generated by fiber optics used in non-FSO spectroscopy systems. Additionally, due to their FSO architecture, FSO spectrometers are able to accurately analyze in-line test samples in situ, without the need to change the conditions of the lines in which said samples are flowing. The FSO design of the spectrometers discussed herein further provides for the ability to place the sensitive components of the spectrometer inside of one or more explosion-proof enclosures. This enables such FSO spectroscopy systems to be installed, and operate, in Class I, Division 1 (“C1D1”) or Class I, Zone 1 hazardous areas.

Wavelength accuracy, resolution, and stability of light output are critical features for near-infrared/infrared (NIR/IR) spectrometers when measuring compositional and physical properties of hydrocarbon gas or liquid streams. For the same hydrocarbon sample measurement, the consistent spectrum for a spectrometer over time and for multiple spectrometers may be required (repeatability and reproducibility of the spectrometer output). Accordingly, there is a need for such spectrometers to have a reliable reference system and method to monitor and correct the spectrometer in near real time for every spectrum output.

The FSO spectroscopy systems taught herein may provide for additional tuning and correcting, both of the laser(s) that they output and of the experimental spectral results that they capture through use of an internal or external reference cell, which may be used to contain a reference fluid. For example, such a reference cell may be used as a wavelength reference component to monitor and/or correct the NIR/IR spectrometer wavelength output in near real time. The spectroscopic prediction models can also be periodically validated with the reference spectrum. The reference cell system may also allow for spectrometer alarms to be generated when, for example, the wavelength drift of the system's laser is over a threshold, or the captured reference spectrum is different than the standard spectrum, or the model prediction results do not match the actual reference fluid properties. Compared with other wavelength reference systems and methods used in spectrometers (e.g. etalon devices), the disclosed reference cell system may be more reliable and consistent.

FSO spectrometers may be particularly useful when dealing with remote or hazardous materials where it may be dangerous or impractical to physically connect a spectrometer to the test sample, such as in monitoring industrial emissions or analyzing samples contained in a vacuum chamber.

Additionally, onboard calibration systems allow for regular tuning of the FSO instrument without the need to physically access the devices, which may be especially difficult and/or dangerous when the subject medium, (and therefore the spectrometer system is in a dangerous location or contains a volatile substance).

FSO spectroscopy systems, such as those contemplated hereby, and the benefits that they are able to provide over conventional spectrometers, may prove advantageous in a multitude of potential applications; including those in and related to oil and gas production, refinement, and distribution.

For example, FSO spectroscopy systems may be used in applications such as, but not limited to, flare gas and flare emissions monitoring for EPA reporting purposes; verification of custody transfer; separation of in-line products and their associated transmixes; control of dual/bi-fuel engines; etc. Each of which will be discussed in further detail hereinbelow.

### BRIEF DESCRIPTION OF THE DRAWINGS

The detailed embodiments described and discussed herein are provided as non-limiting examples of the subject invention, are intended to be illustrative only, and should not be taken as limiting the scope of the invention as defined by any associated claims. Rather, what is claimed as the invention is all such modifications as may come within the spirit and scope of the following claims and equivalents thereto.

When a single embodiment is described herein, it will be readily apparent that more than one embodiment may be used in place of a single embodiment. Similarly, where more than one embodiment is described herein, it will be readily apparent that a single embodiment may be substituted for that one device.

The descriptions in this specification are intended to provide context for the claimed subject matter, and should not be interpreted as limiting the scope of any associated claims to require any unclaimed element, step, or function described herein. The scope of the patented subject matter is defined only by the allowed claims and their equivalents. Unless explicitly recited, other aspects of the present invention as described in this specification do not limit the scope of the claims.

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 shows a perspective view of an exemplary FSO spectroscopy system, in accordance with embodiments.

FIG. 2 shows a simple schematic view of an exemplary FSO spectroscopy system, in accordance with embodiments.

FIG. 3 shows a schematic view of an exemplary FSO spectroscopy system, in accordance with embodiments.

FIG. 4 shows a perspective view of an exemplary FSO spectroscopy system having a sidecar enclosure in accordance with embodiments.

FIG. 5 shows a schematic view of an exemplary FSO spectroscopy system having a sidecar, in accordance with embodiments.

FIG. 6 shows a simplified schematic view of an exemplary FSO spectroscopy system having a single enclosure, in accordance with embodiments.

FIG. 7 shows a flowchart depicting an exemplary embodiment of a method for wavelength correction using FSO spectroscopy system, in accordance with embodiments.

FIG. 8A shows an exemplary output of an exemplary FSO spectroscopy system, in accordance with embodiments.

FIG. 8B shows an exemplary spectral plot depicting the spectra of multiple fluids which may be used to calibrate an FSO spectroscopy system, and/or validate the experimental results of an FSO spectroscopy system, in accordance with embodiments.

FIG. 9A shows a schematic view of an exemplary dual/bi fuel engine system comprising an exemplary FSO spectroscopy system, in accordance with embodiments.

FIG. 9B shows a schematic view of an alternate embodiment of a dual/bi fuel engine system, in accordance with embodiments.

FIG. 10 shows a schematic view of an exemplary metering system comprising an exemplary FSO spectroscopy system, in accordance with embodiments.

FIG. 11 shows a block diagram of an exemplary system for flare monitoring using an FSO spectroscopy system, as discussed herein, in accordance with embodiments.

FIG. 12 shows a block diagram of an exemplary system for custody transferring monitoring using an FSO spectroscopy system, as discussed herein, in accordance with embodiments.

FIG. 13 shows a block diagram of an exemplary system for stabilizing vapor pressure using an FSO spectroscopy system, as discussed herein, in accordance with embodiments.

FIG. 14 shows a block diagram of an exemplary system for transmix separation using an FSO spectroscopy system, as discussed herein, in accordance with embodiments.

### DETAILED DESCRIPTION OF ILLUSTRATIVE EMBODIMENTS

Reference now should be made to the drawings, in which the same reference numbers are used throughout the different figures to designate the same components.

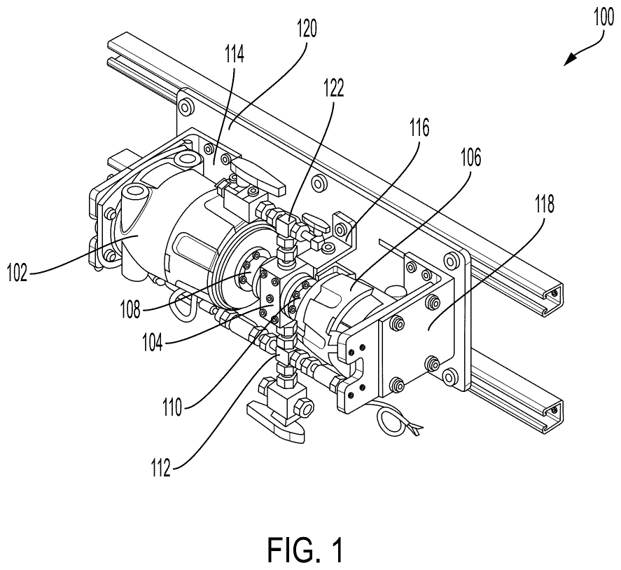

FIG. 1 shows a perspective view of an exemplary FSO spectroscopy system; namely FSO spectroscopy system 100. FSO spectroscopy system 100 may comprise laser enclosure 102 which may be mechanically attached to a first side of flow cell 104, such as by use of adaptor 108. A second side of flow cell 104, opposite that of the side to which laser enclosure 102 is affixed, may be mechanically attached to detector enclosure 106, such as by use of adapter 110.

Data and power may be supplied to and/or between one or more of laser enclosure 102, flow cell 104, and detector enclosure 106, and pipeline products may be introduced into, or flow through, flow cell 104 via inlet 122.

Embodiments of FSO spectroscopy systems discussed herein, such as FSO spectroscopy system 100, may be mounted to mounting plate 120 in order to facilitate mounting of the FSO spectroscopy system to an external structure. In such embodiments one or more of laser enclosure 102, flow cell 104, and detector enclosure 106 may be attached to mounting plate 120 by way of one or more brackets, such as brackets 114, 116, and 118, respectively. In such embodiments mounting plate 120 and bracket(s) 114, 116, and/or 118 may provide the additional benefit of functioning as a heatsink for FSO spectroscopy system 100.

In embodiments, one or more of mounting plate 120 and brackets 114, 116, and/or 118 may operate as a heat sink for the purposes of absorbing and dissipating heat generated by FSO spectroscopy system 100.

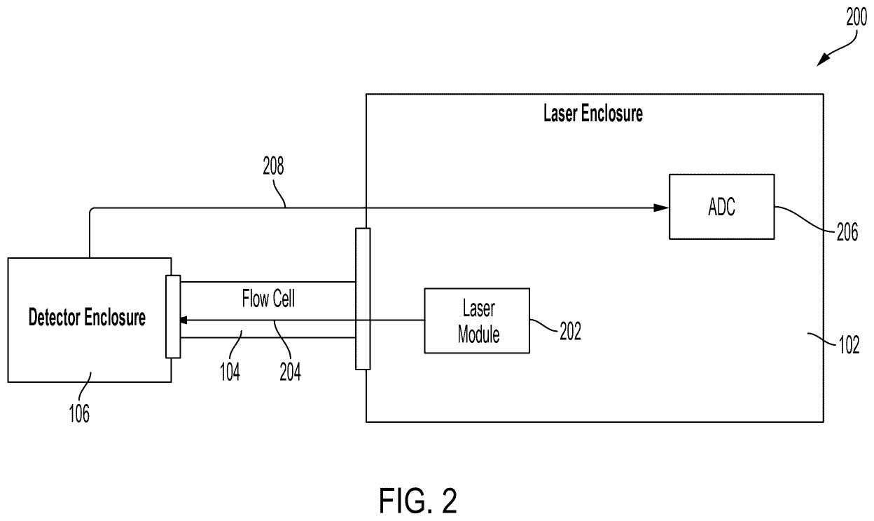

FIG. 2 shows a simple schematic view of an exemplary FSO spectroscopy system; namely, FSO spectroscopy system 200. FSO spectroscopy system 200 shows laser module 202 and analogue to digital converter (“ADC”) 206 enclosed within the interior volume of laser enclosure 102. Laser module 202 may be configured to output laser beam 204, which may pass out of laser enclosure 102, into and through flow cell 104, including any fluids contained therein, before entering detector enclosure 106. Once laser beam 204 is received and interpreted by the components contained within detector enclosure 106 (as may be detailed in reference to other embodiments corresponding to other FIGs), the resultant information (e.g., a photocurrent or voltage signal) may be transmitted from components contained within detector enclosure 106 (such as a transimpedance amplifier (“TIA”) to ADC 206) via data connection 208.

It should be noted that while FIG. 2 depicts a simplified version of the exemplary FSO spectroscopy system for illustrative clarity, this simplified depiction does not limit the scope of the invention or preclude the presence of additional components, including but not limited to those that provide for correction and calibration capabilities as described elsewhere in this application.

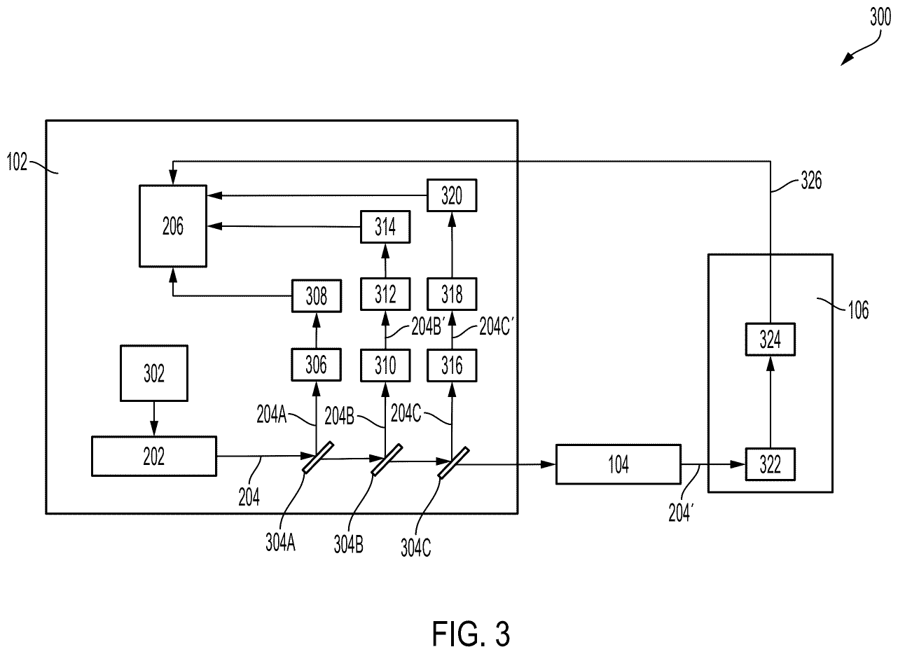

FIG. 3 shows a more detailed schematic view of an exemplary FSO spectrometer; namely, FSO spectroscopy system 300. In FSO spectroscopy system 300 laser enclosure 102 may enclose digital to analogue converter (“DAC”) 302, laser module 202, beam splitters 304A, 304B, and 304C, reference detector 306, transimpedance amplifier (“TIA”) 308, reference cell 310, wavelength reference detector 312, TIA 314, etalon 316, etalon detector 318, TIA 320 and ADC 206; and detector enclosure 106 may enclose signal detector 322 and TIA 324.

DAC 302 may supply a control drive current to laser module 202, which may emit laser 204 responsive thereto. Laser 204 may pass through beam splitters 304A, 304B, and 304C, thereby generating laser beams 204A, 204B, and 204C, respectively. After passing through one or more beam splitters 304A-304C, laser 204 may exit laser enclosure 102, enter and pass through flow cell 104, including the contents contained therein. After passing through flow cell 104 the spectra of laser 204 will have changed due to its interaction with the material(s) contained inside of flow cell 104, resulting in laser beam 204′. Laser beam 204′ may exit flow cell 104 and enter into detector enclosure 106, where it may be received by signal detector 322. Signal detector 322 may capture the laser light output by laser module 202 after it has traveled through flow cell 104, and the material(s) contained therein, (i.e. laser beam 204′) and convert it into electrical signals that may be measured. These electrical signals may be passed from signal detector 322 to TIA 324, which may amplify the photocurrent signals received from signal detector 322 to convert them into usable voltages. The signals (voltage) output from TIA 324 may then be output from detector enclosure 106 and into ADC 206, enclosed within laser enclosure 102.

Before exiting laser enclosure 102, laser beam 204 may be split into a plurality of laser beams; namely laser beams 204A, 204B, and 204C, through the use of one or more beam splitters, such as beam splitters 304A, 304B, and 304C.

Laser beam 204A may be directed to and received by an amplitude reference detector, such as reference detector 306. Reference detector 306 may capture the light from laser beam 204A and convert it into electrical signals that may be measured. These electrical signals may be passed from reference detector 306 to TIA 308, which may amplify the signals received from reference detector 306 to convert them into usable voltages, which may then be passed to ADC 206.

Laser beam 204B may be directed to and pass through reference cell 310, and the contents thereof, resulting in laser beam 204B′, which may be output from reference cell 310 and received by wavelength reference detector 312. Wavelength reference detector 312 may capture the light from laser beam 204B′ and convert it into electrical signals that may be measured. These electrical signals may be passed from wavelength reference detector 312 to TIA 314, which may amplify the signals received from wavelength reference detector 312 to convert them into usable voltages, which may then be passed to ADC 206.

Laser beam 204C may be directed to and into etalon 316. Passing through etalon 316 may result in the conversion of laser beam 204C to laser beam 204C′, which may be output from etalon 316 and received by etalon detector 318. Etalon detector 318 may capture the light from laser beam 204C′ and convert it into electrical signals that may be measured. These electrical signals may be passed from etalon detector 318 to TIA 320, which may amplify the signals received from etalon detector 318 to convert them into usable voltages that may then be passed to ADC 206.

In embodiments of the FSO spectroscopy systems discussed herein, a plurality of beam splitters, such as beam splitters 304A, 304B, and 304C, may be arranged in any suitable configuration to produce three daughter laser beams (e.g., 204A, 204B, and 204C) that may be processed inside laser enclosure 102 and one laser beam, which may also be considered a “daughter beam”, (e.g. 204) which may be output from laser enclosure 102.

In embodiments, reference cell 310, may contain a known reference fluid such as methane gas. In such cases, after laser beam 204B passes through reference cell 310 and its contents, the resulting laser beam 204B′ should possess a spectral signature consistent with having passed through pure methane and nothing else. In such a scenario, wavelength reference detector 312 and TIA 314 process the received laser beam 204B′ to generate a spectral result for the known fluid (e.g., pure methane) contained in reference cell 310. The spectral result for the known fluid contained in reference cell 310 may then be used as a spectral reference against which experimental spectral results captured by FSO spectroscopy system 300 may be compared and calibrated.

A reference fluid contained in reference cell 310 (e.g., pure methane) having a known temperature, pressure, composition, and optical path length has consistent or fixed absorption spectrum features/shapes. A reference spectrum captured by a golden standard spectrometer can be used to qualify a different spectrometer of the same type and correct the spectrometer output if wavelength drift is detected. HITRAN (high-resolution transmission) molecular absorption database provides a “true” absorption spectrum of the reference fluid. This true absorption spectrum may be used to correct the experimental spectral results obtained by the FSO spectroscopy system in order to provide more accurate, corrected experimental spectral results.

It should be noted that the arrangement of the various beam-paths of daughter laser beams 204A/204B/204C and 204A′/204B′/204C′ shown in FIG. 3 after laser beam 204 has been split, and the elements of the system with which said daughter beams interact may vary in sequence. In various embodiments, the paths of the daughter laser beams may be reordered or reconfigured in alternate manners which may be suitable for obtaining the information necessary to perform correction and/or calibration of the FSO spectroscopy system as discussed hereinbelow (i.e., in different embodiments, the first daughter beam split off from the initial laser beam 204 may be routed to the reference cell 310 and wavelength reference detector 312, or to the etalon 316 and the etalon detector 318, rather than to the reference detector 306, as long as a sub-beam is transmitted to each of the appropriate components).

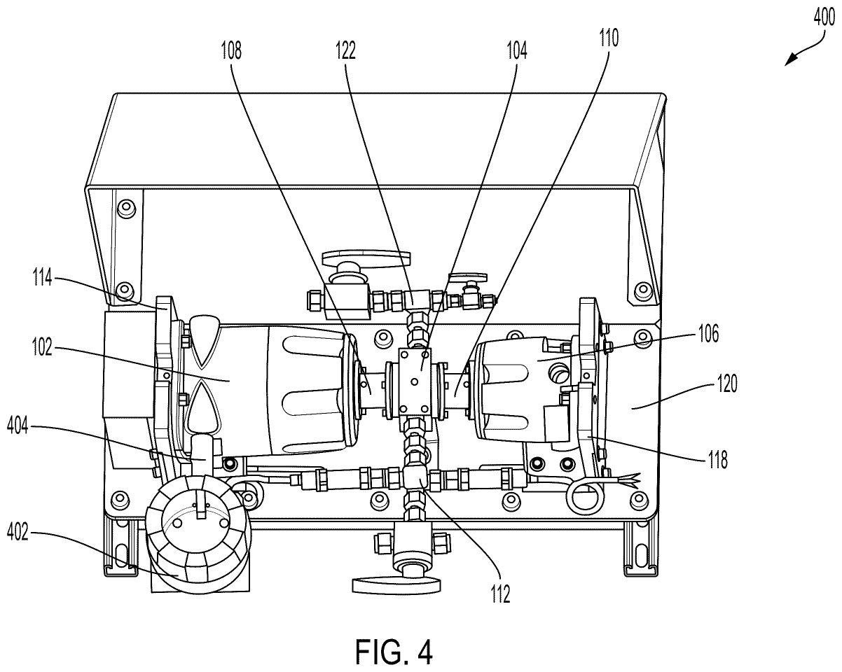

FIG. 4 shows a perspective view of an alternate embodiment of an exemplary FSO spectroscopy system; namely FSO spectroscopy system 400. FSO spectroscopy system 400 is similar to FSO spectroscopy system 100 of FIG. 1, but further comprises sidecar enclosure 402, which may be mechanically affixed to laser enclosure 102, such as by way of bracket 404.

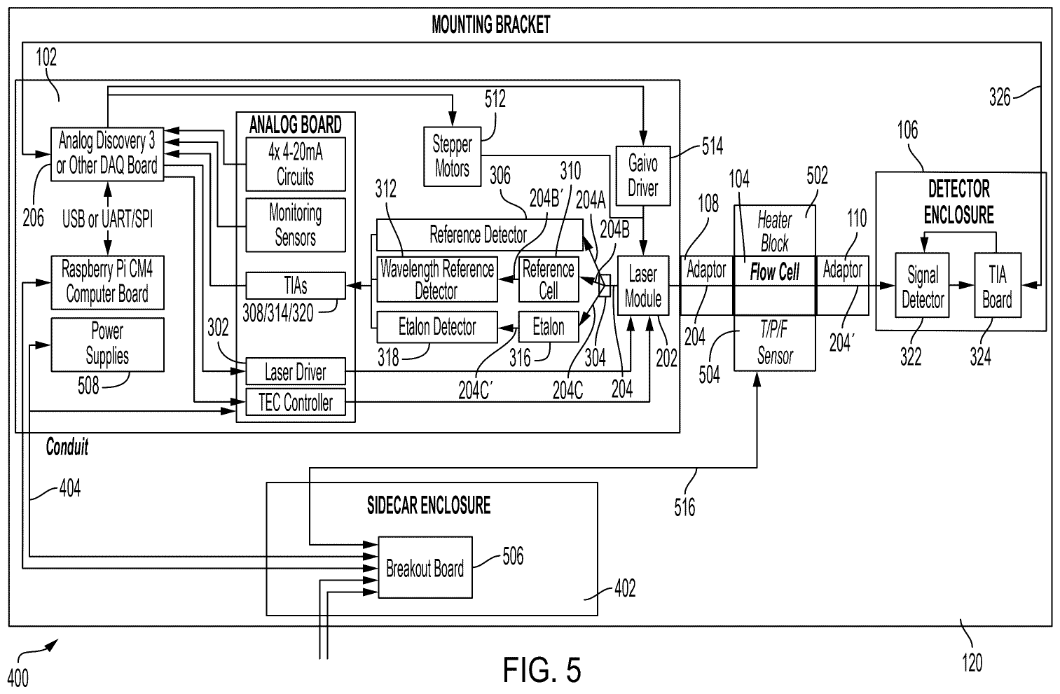

FIG. 5 shows a schematic view of an exemplary FSO spectroscopy system, in accordance with embodiments; namely FSO spectroscopy system 500.

FSO spectroscopy system 500 is similar to the schematic view of FSO spectroscopy system 300 of FIG. 3 and contains the constituent elements thereof, including, but not limited to, beam splitter 304, reference detector 306 reference cell 310, wavelength reference detector 312, etalon 316 and etalon detector 318, and further depicts: laser enclosure 102 as comprising power supply 508, monitoring sensor(s) 510, stepper motor 512 and galvo driver 514; and flow cell 104 comprising heater block 502 and sensor(s) 504; and sidecar enclosure 402 comprising breakout board 506.

Power supply 508, retained in laser enclosure 102 may be configured to receive external electrical power and to process and distribute said power in order to facilitate the function of the electrical components of FSO spectroscopy system 500.

Stepper motor(s) 512 may be used for precise control of mechanical movements within the instrument. Their ability to move in discrete steps allows for accurate positioning and adjustment of various optical and mechanical components of such FSO spectroscopy systems, such as laser beam alignment.

Galvo driver 514 may be configured to control the movement of one or more galvo mirrors (not shown), allowing for the precise steering of light beams within FSO spectroscopy systems. In embodiments, galvo driver 514 may control a filter (not shown) inside of laser module 202 so that the wavelength of a laser beam being output by laser module 202 scans through a predetermined range of wavelengths. In embodiments, such wavelength scanning may be performed continuously.

Heater block 502 may allow for temperature control of the contents of flow cell 104, as thermal fluctuations can lead to variations in the refractive index, density, and other physical properties of the sample material contained in flow cell 104, which in turn can affect the accuracy of the experimental spectroscopic data captured by FSO spectroscopy system 500. Heater block 502 may also be used to avoid condensation in the case of a gas stream passing through flow cell 104; or window fouling, which may also occur due to liquid passing through flow cell 104.

Sensor(s) 504 may comprise one or more of a temperature sensor, a pressure sensor, and a flow sensor. Sensor(s) 504 may be configured to monitor the physical characteristics of the materials flowing through flow cell 104 in near real time, and to transmit the information so captured to a processing portion of FSO spectroscopy system 500, where they may be used to refine the experimental spectral results captured by the system. In embodiments, sensors, such as sensor(s) 504 may monitor the material in a fluid connection coupled to the flow cell, such as fluid connection 112 depicted in FIG. 1 and FIG. 4.

Sidecar enclosure 402 may be connected to laser enclosure 102 by conduit 404 for the purposes of data and/or power transmission therebetween. Similarly, sidecar enclosure 402 may be connected to flow cell 104 (which includes heater block 502 and sensor(s) 504) via conduit 516 for the same purposes.

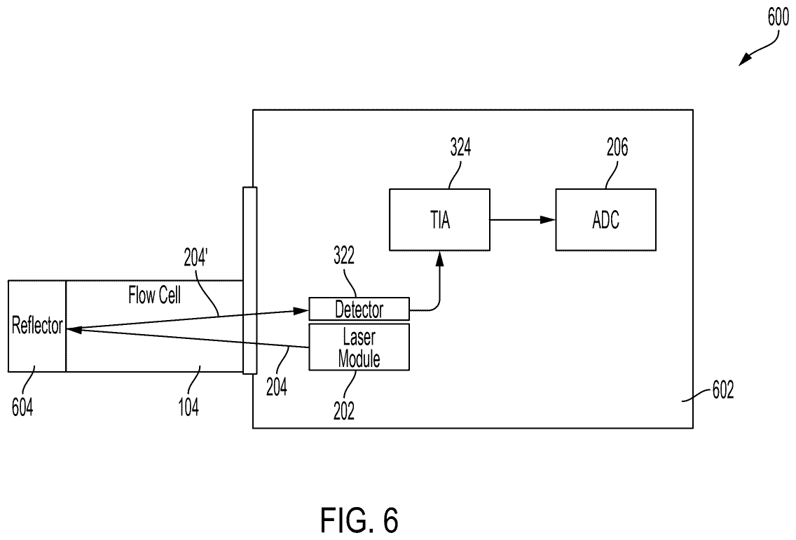

FIG. 6 shows a particular embodiment of an FSO spectroscopy system; namely, FSO spectroscopy system 600, comprising only a single enclosure, enclosure 602. In such an embodiment, signal detector 322 and TIA 324, which have been previously discussed as being in a second enclosure (a “detection enclosure”), that is separate from the “laser enclosure”, are instead enclosed in enclosure 602 along with the other components of the FSO spectroscopy systems generally included in the laser enclosure. In such embodiments, instead of having a detection enclosure positioned on the side of the flow cell opposite the laser enclosure, flow cell 104 may comprise reflector 604 positioned on an end of flow cell 104 opposite enclosure 602. Reflector 604 may be positioned and configured such that laser beam 606, generated by laser module 202 enclosed within enclosure 602, may be received and reflected by reflector 604 after passing through flow cell 104 (and the material(s) contained therein). This reflection of laser beam 606 by reflector 604 may cause said laser to travel back through flow cell 104 (and the material(s) contained therein) and back into enclosure 602 after which the laser beam so modified (laser beam 606′) may be received by signal detector 322, contained therein. The resulting electrical signal generated by signal detector 322 may then be passed to and processed by TIA 324, which is also located inside of enclosure 602, and input into ADC 206 in order to generate an experimental spectral result for the material(s) inside of flow cell 104.

It should be noted that exemplary FSO spectroscopy system 600, depicted in FIG. 6, has been intentionally simplified such that it does not depict certain elements typically present in such FSO spectrometer systems, as contemplated by this disclosure, in order to highlight a particular design of some embodiments of FSO spectrometer systems which may use reflector 604 to route laser beam 606/606′ back through flow cell 104 and back into enclosure 602 where it may be received by detector 322, instead of having detector 322 housed in a separate enclosure from the one that houses laser module 202 (as is depicted in FIGS. 1-5) and that the additional components of such FSO spectroscopy systems which may be necessary for the calibration/correction of the FSO spectroscopy system, as shown in, for example, FIG. 3 and FIG. 5 (e.g., components such as a beam splitter 304 or 304A/304B/304C, reference detector 306, reference cell 310, wavelength reference detector 312, etalon 316, etalon detector 318, and the TIA(s) associated with such detectors), which may also be included in such embodiments of FSO spectroscopy systems that use a reflector, like reflector 604, without departing from the scope of this disclosure.

FSO spectroscopy systems, such as those depicted in FIGS. 1-6, may be used to analyze fluids at line conditions in near real time. Moreover, such systems comprising the means for tuning and correction of the FSO spectroscopy system (i.e., those having a reference cell and associated testing and correction systems) may not only capture experimental spectral results from the materials that they measure, but they may also correct such experimental spectral results using spectral results obtained from analysis of the reference material in the system's reference cell, and comparing that with an etalon spectrum captured by the system, and a known spectrum for the reference material (which may be obtained from a database of such known spectrum) in order to provide for more accurate experimental results.

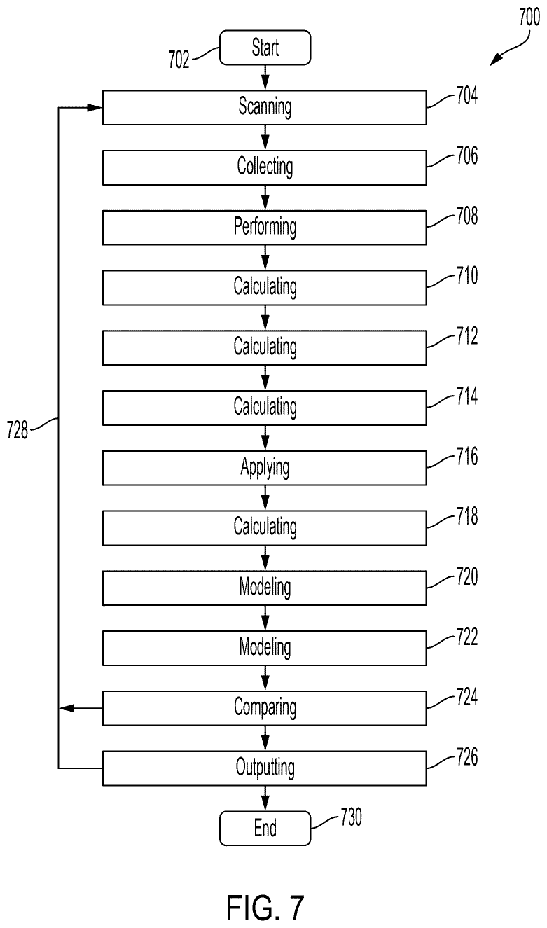

FIG. 7 shows a flowchart depicting an exemplary embodiment of a method for wavelength correction using an FSO spectroscopy system, in accordance with embodiments; namely method 700. Method 700 may begin 702 the process of wavelength correction, which may comprise the steps of: transmitting a laser through a specimen and scanning 704 the laser through a range of wavelengths; collecting 706 spectra from the detectors (i.e., the signal detector, amplitude reference detector, wavelength reference detector, and etalon detector); performing 708 dark current corrections on the spectra received from the detectors; calculating 710 the wavelength reference absorption spectrum; calculating 712 the wavelength offset by comparing the wavelength reference absorption spectrum and the true standard gas spectrum (HITRAN) based on the absorption features of the reference fluid (e.g., methane gas); calculating 714 wavelength linear and nonlinear corrections equations from the etalon spectrum; applying 716 wavelength correction (offset, linear, and nonlinear) to all spectra; calculating 718 the signal absorption spectrum; modeling 720 the prediction to signal absorption spectrum for speciation and physical properties of the measured fluid; modeling 722 the prediction to wavelength reference absorption spectrum for speciation and physical properties of the reference fluid; comparing 724 the wavelength reference model prediction results against known reference fluid values to validate the model performance; and outputting 726 one or more of spectra and model prediction results to one or more of a user interface and a database, after which method 700 may end 730.

In embodiments, method 700 may comprise loop 728 which may cause method 700 to iterate itself starting at scanning 704 in order to provide for continuous correction of the experimental results obtained from operation of the FSO. As is depicted in FIG. 7, in various embodiments, loop 728 may begin after either comparing 724 or outputting 726.

More specifically, in some embodiments, scanning 704 may comprise using an FSO spectroscopy system to emit a single wavelength laser light that scans through a wavelength range covering approximately 1,590 nm to 1,800 nm over a period of time. The wavelength range through which the laser may scan may be larger or smaller and may range from wavelengths below 1,590 nm to ones above 1,800 nm (the specific range described above has been selected due to it being suitable for generally covering hydrocarbon absorption overtone bands, and is not intended on limiting the scope of this disclosure to only that specific range of wavelengths). In embodiments, the step resolution of the frequency sweep that occurs during scanning 704 may be approximately 0.03 nm, but other, different step resolutions are also contemplated hereby. Similarly, in embodiments, the time period through which scanning 704 may occur may be approximately 100 milliseconds, but both shorter and longer time periods for scanning 704 are also contemplated hereby.

In embodiments, collecting 706 occurs after the laser emitted by the FSO spectroscopy system has reached the various detectors included in the FSO spectroscopy systems, such as reference detector 306, wavelength reference detector 312, etalon detector 318, and signal detector 322 (see FIG. 3), the resultant photocurrent signals from those detectors are then amplified by their respective TIAs (308, 314, 320, and 324) and then converted to digital signals by ADC 206, and stored to memory as separate spectra I_{signal_collected}, I_{amplitud_collected}, I_{wavelength_collected}, and I_{etalon_collected}, each having a number of datapoints determined by dividing the wavelength range through which the laser beam scans during scanning 704 divided by the step resolution of the laser beam during said scanning 704.

In embodiments, performing 708 dark current corrections on the spectra received from the detectors comprises determining a dark current signal (the photocurrent generated by a detector when there is no light hitting the detector-Ix DC) and subtracting each of the detectors' respective dark current signal from each of the data points of the spectra collected by said detectors in collecting 706.

$${I}_{signal \_ DCC} = {I}_{signal \_ collected} - {I}_{signal \_ DC}$$

$${I}_{amplitude \_ DCC} = {I}_{amplitude \_ collected} - {I}_{amplitude \_ DC}$$

$${I}_{wavelength \_ DCC} = {I}_{wavelength \_ collected} - {I}_{wavelength \_ DC}$$

$${I}_{etalon \_ DCC} = {I}_{etalon \_ collected} - {I}_{etalon \_ DC}$$

Embodiments may provide for the dark current signals for each detector to be collected periodically during operation of the FSO spectrometry system by stopping the emission of the laser beam or blocking the laser beam from reaching the detectors.

In embodiments, performing 708 dark current correction on the spectra received from the detectors may comprise using a modeling method, such as linear or polynomial regression, to determine an average offset for the spectra across a range of measured wavelengths, which may then be applied across the entire experimentally collected spectrum for correction purposes.

In embodiments, calculating 710 the wavelength reference absorption spectrum may comprise dividing I_{amplitude_DCC} by I_{wavelenth_DCC} and taking the logarithm of the result thereof for each of the datapoints collected during the scanning 704 and collecting 706.

$${A}_{wavelength} = log ( {I}_{amplitude \_ DCC} / {I}_{wavelength \_ DCC} )$$

In embodiments, calculating 712 the wavelength offset may comprise comparing the wavelength reference absorption spectrum determined in calculating 710 (A_{wavelength}) against a known absorption spectrum for a known reference fluid contained in the FSO spectrometer system's reference cell 310 (i.e., a HITRAN spectrum); identifying corresponding absorption features between the measured and known spectra; and determining a wavelength offset between the measured wavelength absorption spectrum for the reference fluid in reference cell 310 and the HITRAN spectrum for the same material. In embodiments, known methodologies such as linear or polynomial regression analysis may be used to determine an average offset for the spectrum, which may then be applied across the entire spectrum for the purposes of wavelength offset correction.

$${Offset}_{wavelength} = {A}_{wavelength \_ HITRAN} - {A}_{wavelength}$$

While calculating 712 the wavelength offset may allow for wavelength offset correction, it does not provide for linear and nonlinear errors that may result from the laser wavelength scan.

In embodiments, calculating 714 wavelength linear and nonlinear correction equations from the etalon spectrum may comprise applying flattening algorithms to the spectrum obtained from the portion of the laser beam passing through etalon 316 and being received by etalon detector 318 to determine one or more of a linear or polynomial curve (i.e., a wavelength correction equation), which may be applied to the experimental results of the FSO spectroscopy system's measurement of the fluid in flow cell 104 in order to further correct and/or validate the wavelength scale of the spectrometer system (i.e., the x-axis assignment of the measured spectrum).

In embodiments, applying 716 wavelength correction (offset, linear, and/or nonlinear) to all spectra may comprise applying the wavelength offset determined in calculating 712 and the linear and nonlinear wavelength correction equations determined in calculating 714 to each of the dark current corrected spectra in order to determine corresponding wavelength corrected spectra, where “F” represents the wavelength correction function defined by the offset, linear, and/or nonlinear corrections determined in the steps of calculating 712 and calculating 714.

$${I}_{signal \_ Wcorrected} = F [ {I}_{signal \_ DCC} ]$$

$${I}_{amplitude \_ Wcorrected} = F [ {I}_{amplitude \_ DCC} ]$$

$${I}_{wavelength \_ Wcorrected} = F [ {I}_{wavelength \_ DCC} ]$$

$${I}_{etalon \_ Wcorrected} = F [ {I}_{etalon \_ DCC} ]$$

$${A}_{wavelength \_ Wcorrected} = F [ {A}_{wavelength \_ DCC} ]$$

In embodiments, calculating 718 the signal absorption spectrum may comprise dividing I_{amplitude_Wcorrected} by I_{signal_Wcorrected} and taking the logarithm of the result thereof for each of the datapoints collected during scanning 704 and collecting 706.

$${A}_{signal} = log ( {I}_{amplitude \_ Wcorrected} / {I}_{signal \_ Wcorrected} ) .$$

In embodiments, modeling 720 the prediction to signal absorption spectrum for speciation and physical properties of the measured fluid may comprise applying a set of chemometric models to the signal absorption spectrum (A_{signal}), which may result in the determination, and output of the concentrations of the components of the sample fluid contained in flow cell 104 (e.g., methane, ethane, propane, etc.) and its physical properties (e.g., heating values, vapor pressures, relative/absolute density, octane numbers, boiling points, flash points, etc.). Modeling 720 may also be used to determine and output multiple diagnostic parameters indicating the confidence level of the prediction results.

In embodiments, modeling 722 the prediction to wavelength reference absorption spectrum (A_{wavelength}) for speciation and physical properties of the reference fluid in reference cell 310 may comprise applying similar sets of chemometric models used in modeling 720 to the wavelength reference absorption spectrum (A_{wavelength}), rather than to the signal absorption spectrum (A_{signal}), in order to determine the accuracy and stability of the wavelength calibration of the FSO spectroscopy system and/or determine the extent of any wavelength axis shift or distortion in the measured absorption spectrum (A_{signal}). In embodiments, such modeling may be performed periodically during the operation of the FSO spectroscopy system.

In embodiments, comparing 724 the wavelength reference model prediction results against known reference fluid values to validate the model performance may comprise using the chemometric modeling of modeling step 722 to predict the concentration of a particular known fluid inside of reference cell 310 and comparing the resulting prediction against the known concentration of that component of the reference fluid. If the model predicted concentration is outside of an acceptable range (for example, ±1%) the FSO spectroscopy system may flag that discrepancy as an issue, which may result in, for example, identifying the results as unreliable, alerting a user of the FSO spectroscopy system, re-measurement of the test sample, recalibration of the FSO spectroscopy system, or otherwise troubleshooting the measurement process, etc.

The same set of models may be applied to the signal absorption spectrum (A_{signal}). For example, if the reference cell is filled with pure methane gas, the chemometric modeling 722 may be used to predict the concentration of said reference cell gas with the target concentration being 100% methane. If in comparing 724 the model predicted concentration is far from the target concentration (for example outside 100%±1% range), an alarm may be generated indicating that the spectrometer system needs to undergo troubleshooting.

Additionally, in embodiments, the model predicted hydrocarbon concentrations and fluid properties may be compared with known target values to validate the performance of both the FSO spectrometer system and the chemometric models being used in method 700.

In embodiments, outputting 726 one or more of spectra and model prediction results to one or more of a user interface and a database may comprise communicating said information via one or more suitable communication protocols (such as, but not limited to, Modbus, 4-20 mA outputs, MQTT, OPC UA, Wi-Fi, etc.) to a graphical user interface associated with the FSO spectroscopy system, a web application, a remote computing device, and/or a local or remote memory storage device. If the information is transmitted to a device with a graphical user interface, said information may further be displayed on said graphical user interface.

The operation of an FSO system in accordance with methods such as that which is depicted in FIG. 7 may result in the collection of an experimental spectral result, which may be recorded and/or output to a graphical user interface.

In embodiments, such FSO spectroscopy systems may obtain both experimental spectral results of samples being tested, and of materials contained in their reference cells, and etalons, and may be able to obtain spectra of known materials from databases; in which case, such systems may be able to correct for errors in their experimental spectral results based on the other spectra so obtained.

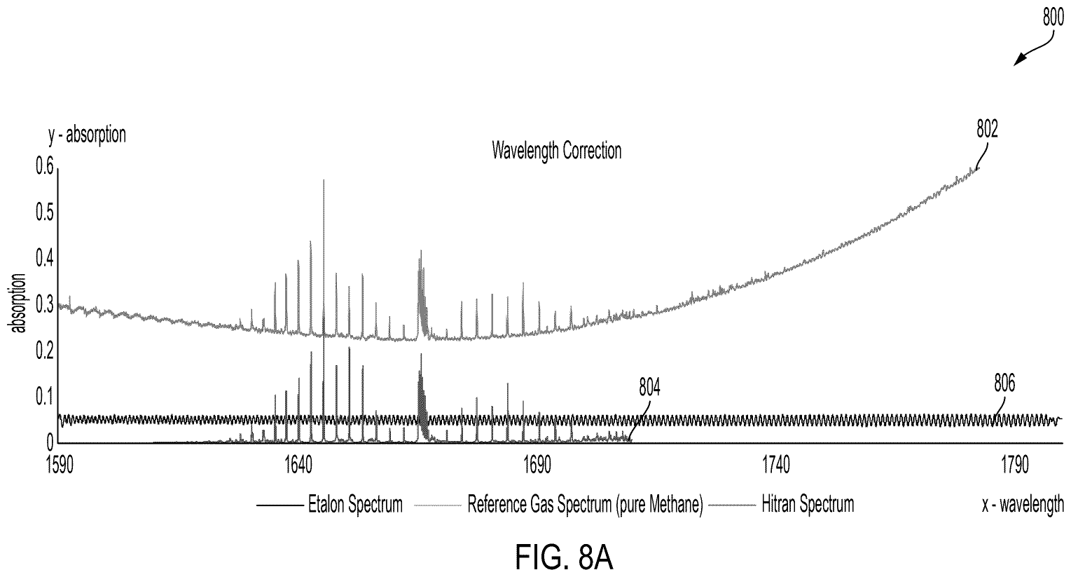

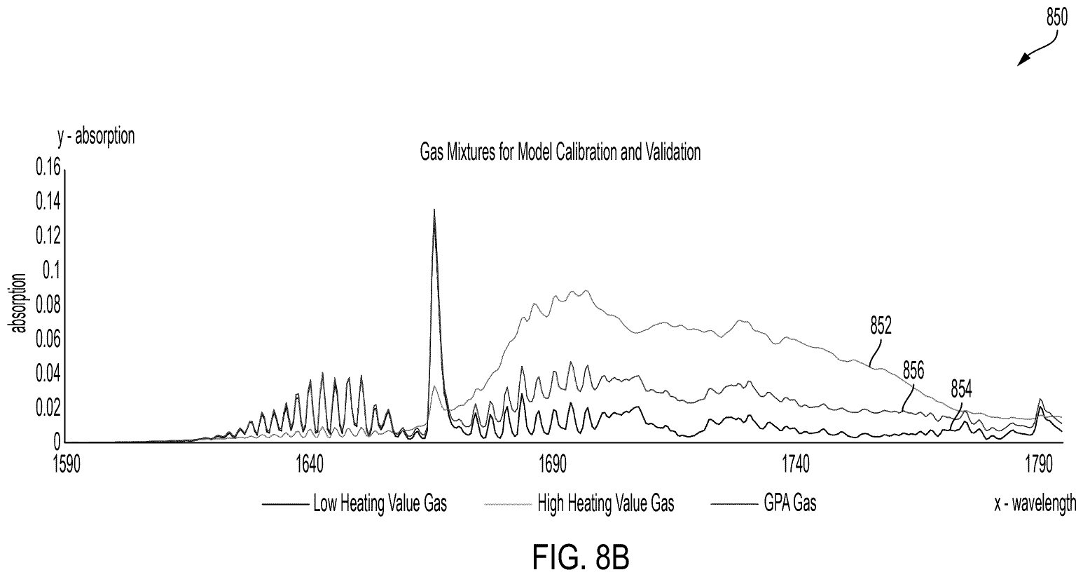

FIG. 8A shows an exemplary output of an exemplary FSO spectroscopy system, in accordance with embodiments. Output 800 may be displayed on a graphical user interface and may comprise a graph. In embodiments, the x-axis of graph 800 may correspond to the wavelength of light, while the y-axis of graph 800 may correspond to absorption. Graph 800 may display one or more of reference spectrum 802, HITRAN spectrum 804, and/or etalon spectrum 806. HITRAN spectrum 804 may be the true spectral results for the reference material, which may be obtained from a public database (e.g., https://hitran.org/).

By comparing peak position between reference spectrum 802 and HITRAN spectrum 804, wavelength (shown on the x-axis) may be corrected. However, the reference spectrum 802 peaks only cover part of the spectrometer wavelength scan range. The etalon spectrum 806 may be used to correct the FSO spectroscopy system's wavelength scale across the full wavelength range.

Etalon spectrum 806 has well-known sinusoidal periodic peaks across a wide range of wavelengths. These peaks can be used to correct the experimental wavelength scale by ensuring that the measured peaks of the etalon spectrum match their expected positions. Any deviations in the wavelength positions can be attributed to the instrument (e.g., drifts in the FSO spectroscopy system's detector or optical components), which can be corrected using the etalon's reference peaks. Basically, if the reference etalon spectrum 806 deviates from what is expected; namely a sinusoidal wave with consistent peaks along a set wavelength, the FSO spectroscopy system can measure and correct for that deviation (such as by determining an equation that would correct the tested etalon spectrum such that it would have consistent peaks across all wavelengths, whether it be linear or nonlinear) and apply that correction to the FSO spectroscopy system's experimental spectral results in order to further correct and/or validate them. This is essentially an embodiment of calculating 714 wavelength linear and nonlinear corrections equations from the etalon spectrum.

Accordingly, by using all three spectra (the reference spectra 802, the HITRAN spectrum 804, and the etalon spectrum 806), wavelength correction can be realized for the full spectral range.

FIG. 8B shows an exemplary spectral plot 850 depicting the spectra of multiple fluids which may be used to calibrate an FSO spectroscopy system, and/or validate the experimental results of an FSO spectroscopy system, in accordance with embodiments. In the embodiment depicted in FIG. 8B, line 852 depicts the spectra of a high heating value gas consisting of 50% ethane, 40% propane, and 10% methane; line 854 depicts the spectra of a low heating value gas consisting of 70% methane and 30% nitrogen; and line 856 depicts the spectra of a GPA-spec gas consisting of 70.5% methane, 9% ethane, 6% propane, 5% nitrogen, 3% isobutane, 3% n-butane, 1% isopentane, 1% n-pentane, 1% carbon dioxide, and 0.5% helium. The compositional differences make the different absorption spectra for these three gases. The tests resulting in these spectra may be used to calibrate and validate the FSO spectroscopy system during factory testing as well as periodic calibrations. In embodiments, the GPA-spec gas may be retained in the reference cell and used for more frequent validations/calibrations of the FSO spectroscopy system.

In embodiments the spectra may be projected into a principal component analysis (PCA) space. In such embodiments the plotting of points that represent the spectra of stable products should be clustered together due to their similar composition.

In embodiments, the steps of recording, plotting, and analyzing the spectra information from pipeline product samples may be performed by a microprocessor, or embedded computer, configured for such tasks.

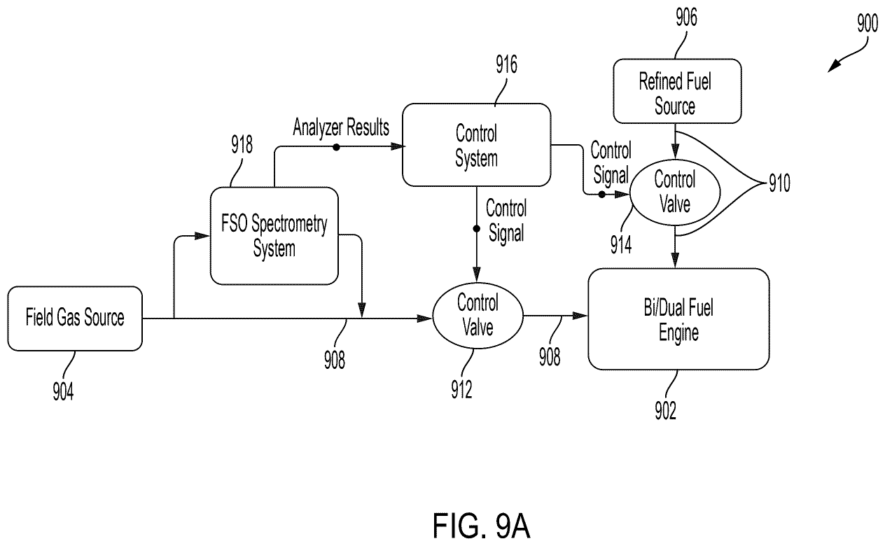

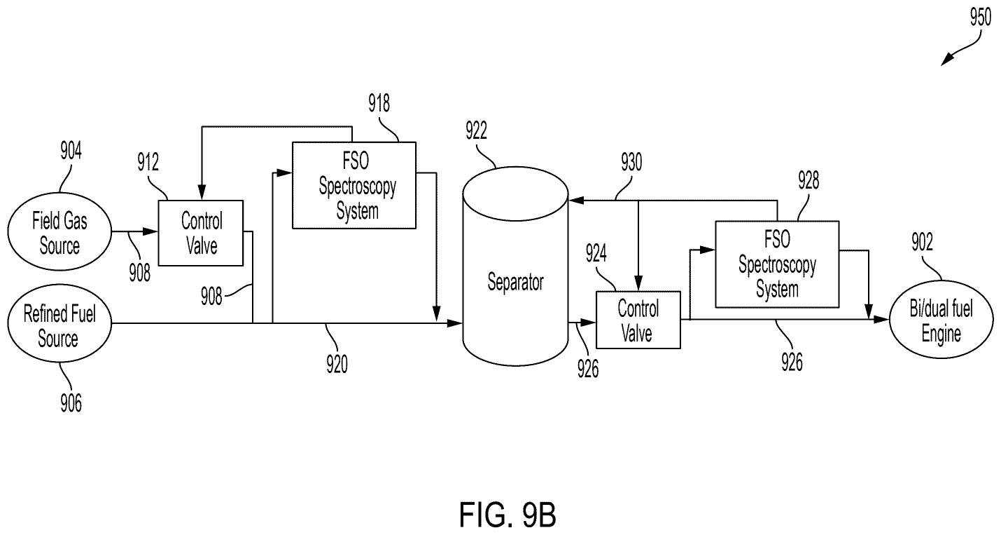

Spectroscopy systems, including FSO spectroscopy systems such as those disclosed herein, may be used to monitor the composition of fluids in near real time. Such near-real-time monitoring may be useful for the performance of a multitude of functions across many industries. One potential use case for embodiments of the FSO spectroscopy systems disclosed herein; namely that of dual/bi fuel engine monitoring and management, is depicted in FIG. 9A and FIG. 9B.

In the embodiment of such a use case depicted in FIG. 9; namely dual/bi fuel engine system 900, dual/bi fuel engine 902 may be connected to two or more potential sources of fuel such as field gas source 904 and refined fuel source 906, which may contain a known fuel source (such as, for example, diesel fuel, compressed natural gas, etc.) by field gas fuel line 908 and refined fuel line 910, respectively. Each of the fuel lines 908, and 910, may comprise a control valve, such as control valves 912 and 914, respectively, which may be used to controllably permit or restrict the flow of fuel to dual/bi fuel engine 902 through the fuel line. Control valves 912 and 914 may each be connected to and controlled by control system 916. FSO spectroscopy system 918 may be connected to control system 916 and to field gas fuel line 908 connecting field gas source 904 to dual/bi fuel engine 902 and may be configured to monitor the composition of the material(s) flowing through field gas fuel line 908 in near real time.

Field gas typically provides a more cost-effective option for powering engines compared to more processed/refined fuels, such as diesel or compressed natural gas. Accordingly, companies may prefer to utilize field gas to power their equipment in order to reduce costs. Due to field gas being less processed than other fuels, it exhibits less consistency in its composition and therefore is more likely to include materials that could damage engines or cause them to run poorly or otherwise have issues functioning. Thus, while it may be beneficial to bias the running of equipment off of field gas when possible, it can be advantageous to supplement the field gas with a more refined fuel, especially when the composition of the field gas is outside of acceptable parameters.

In embodiments of such dual/bi fuel engine systems, such as system 900, control system 916 may be programmed to minimize the amount of refined fuel being provided to dual/bi fuel engine 902, while FSO spectroscopy system 918 determines that the composition of the field gas flowing through field gas fuel line 908 and to dual/bi fuel engine 902 is within established parameters. Control system 916 may be further programmed to restrict the flow of field gas to dual/bi fuel engine 902 through field gas fuel line 908 and permit/increase the flow of refined fuel to dual/bi fuel engine 902 through refined fuel line 910 responsive to FSO spectroscopy system 918 determining that the composition of the field gas flowing through field gas fuel line 908 is outside of established parameters. Control system 916 may achieve such restriction and/or permitting/increase via actuation of control valves 912 and 914. By reducing the supply of field gas and increasing the supply of refined fuel to dual/bi fuel engine 902 responsive to FSO spectroscopy system 918 determining that the field gas flowing through field gas fuel line 908 dual/bi fuel engine system 900 can ensure that the changing composition of the field gas does not negatively affect the operation of dual/bi fuel engine 902.

FIG. 9B shows a schematic view of an alternate embodiment of a dual/bi fuel engine system. In the embodiment of the dual/bi fuel engine system depicted in FIG. 9B; namely dual/bi fuel engine system 950, dual/bi fuel engine 902 may be connected to two or more potential sources of fuel such as field gas source 904 and refined fuel source 906, like dual/bi fuel engine system 900 of FIG. 9A, but in a different manner. In dual/bi fuel engine system 950 fuel from refined fuel source 906 may flow to separator 922 via field gas fuel line 908 and mixed fuel supply line 920. Control valve 912 may be positioned at some point along field gas fuel line 908 before it flows into mixed fuel line 920. Control valve 912 may be operable to controllably regulate the flow of field gas from field gas source 904 to mixed fuel line 920 and thereby to separator 922. In contrast, refined fuel source 906 may be connected to separator 922 directly by mixed fuel line 920. FSO spectroscopy system 918 may be in fluid communication with mixed fuel line 920 at a point between where it connects to field gas fuel line 908 and to separator 922, and may be configured such that it flows a sample of the fluid flowing through mixed fuel line 920 through its flow cell such that it can perform a spectroscopic analysis of a sample of fluid flowing through mixed fuel supply line 920 in near real time. FSO spectroscopy system 918 may be communicably connected to control valve 912 such that control valve 912 may control the metering of field gas from field gas source 904 to mixed fuel line 920 and therefore to FSO spectroscopy system 918 and to separator 922 responsive to the analysis performed by FSO spectroscopy system 918 in near real time.

Separator 922 may be configured to remove contaminates (e.g., water, solids particles, etc.) from the fuel that it receives from field gas source 904 and refined gas source 906 via mixed fuel line 920, after which the processed fuel may flow to bi/dual fuel engine 902 via fuel line 926. A second control valve, control valve 924 may be positioned along fuel line 926 and operable to controllably regulate the flow of fuel from separator 922 to bi/dual fuel engine 902. A second FSO spectroscopy system, FSO spectroscopy system 928 may be in fluid communication with fuel line 926 at a point between where it connects to control valve 924 and to bi/dual fuel engine 902, and may be configured such that it flows a sample of the fluid flowing through fuel line 926 through its flow cell such that it can perform a spectroscopic analysis of a sample of fluid flowing through fuel supply line 926 in near real time. FSO spectroscopy system 928 may be communicably connected to control valve 924 such that control valve 924 may control the metering of fuel from separator 922 FSO spectroscopy system 928 and to bi/dual fuel engine 902 responsive to the analysis performed by FSO spectroscopy system 928 in near real time.

In embodiments, if FSO spectroscopy system 918 determines that the material flowing through mixed fuel line 920 is outside of predetermined parameters (such as, for example, too low of an octane, too high of a heating value, too much of a particular type of contaminate, etc.) it may send a signal to control valve 912, responsive to which control valve 912 may modulate the flow of field gas therethrough until the point that the material flowing through mixed fuel line 920 is experimentally determined by FSO spectroscopy system 918 to be within the predetermined parameters.

For example, if FSO spectroscopy system 918 performs a spectroscopic analysis of the fluid flowing through mixed fuel line 920 and determines that the heating value of the fluid is too high it may send a signal to control valve 912, responsive to which control valve 912 may reduce the amount of field gas being supplied to mixed fuel line 920 until a point at which FSO spectroscopy system 918 re-analyzes the fluid running thorough mixed fuel line 920 and determines that the heating value of said fluid is once again within acceptable parameters.

In embodiments, parameters that may be measured by FSO spectroscopy system 918 and used to determine whether the flow of field gas from field gas source 904 to separator 922 should be reduced or increased include, but are not limited to, octane rating, heating value, water content, particulate content, hydrocarbon composition, and presence of contaminants.

In embodiments, if FSO spectroscopy system 918 determines that the material flowing through fuel line 926 is outside of predetermined parameters (for example, that it contains too much water) it may send a signal to control valve 924, responsive to which control valve 924 may modulate the flow of fuel therethrough, until the point that the material flowing through fuel line 926 is experimentally determined by FSO spectroscopy system 928 to be within the predetermined parameters.

For example, if FSO spectroscopy system 928 performs a spectroscopic analysis of the fuel flowing through fuel line 926 and determines that the concentration of water in the fuel is too high, it may send a signal to control valve 924, responsive to which control valve 924 may reduce the amount of fuel being supplied to fuel line 926, and therefore to bi/dual fuel engine 902, so that it may be further processed by separator 922 to remove additional water therefrom. The fuel that FSO spectroscopy system 928 determines is outside of acceptable parameters for use in bi/dual fuel engine 902 may be sent back to separator 922 via line 930 where it may be further processed to remove contaminates before being sent back through fuel line 926 and control valve 924 to FSO spectroscopy system 928 for re-analysis. Then after FSO spectroscopy system 928 reanalyzes the fuel in fuel line 926 and determines that the concentration of contaminants in the fuel (e.g., water) therein is back within an acceptable range, FSO spectroscopy system 928 may signal control valve 924 to increase the flow of fuel therethrough, to bi/dual fuel engine 902.

In embodiments, parameters that may be measured by FSO spectroscopy system 928 and used to determine whether the fuel flow from separator 922 to bi/dual fuel engine 902 should be reduced or increased include but are not limited to octane rating, heating value, water content, particulate content, hydrocarbon composition, and presence of contaminants.

Using systems such as that described in FIG. 9A and FIG. 9B, operators may enable their systems to run at least partially off of less expensive field gas rather than more refined products, while still ensuring that the equipment continues to run in the event that the field gas is unsuitable for such use (by way of on-demand fuel supplementation using such more expensive products).

The process of measuring and controlling the addition of different products to a pipeline, such as that described in regard to the operation of dual/bi fuel systems 900 and 950 of FIG. 9A and FIG. 9B, respectively, is sometimes known as metering.

Metering refers to the accurate measurement and monitoring of the quantity and quality of oil, natural gas, or other hydrocarbons as they are extracted, transported, and processed. Metering plays a crucial role throughout the oil and gas supply chain, ensuring that the right amounts of different products are added to a pipeline, or otherwise ensuring that the flow of hydrocarbons is properly accounted for, and enabling financial, operational, and regulatory decisions to be made based on precise data.

Many metering applications require the addition of one product to another such that the resulting mix has a composition falling within specified parameters. FSO spectroscopy systems, such as those contemplated hereby, may be helpful in monitoring and controlling the metering of such pipeline products.

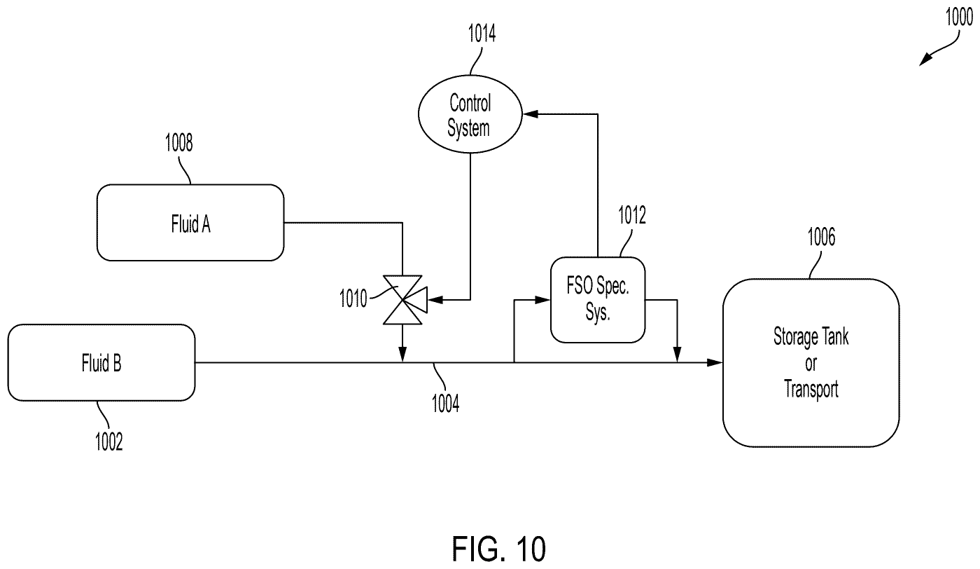

FIG. 10 shows a schematic view of an exemplary metering system comprising an exemplary FSO spectroscopy system, in accordance with embodiments. Metering system 1000 may comprise product 1002 flowing through line 1004 to end location 1006. Line 1004 may be connected to product 1008 via valve 1010, which may be controlled in order to meter the amount of product 1008 that is added to product 1002 flowing through line 1004. FSO spectroscopy system 1012 may be connected to line 1004 at a point after valve 1010 and may be configured to analyze the composition of the fluid flowing through line 1004 in near real time. Control system 1014 may be communicably connected to FSO spectroscopy system 1012 and valve 1010 and may be programmed to control valve 1010 responsive to the analysis performed by FSO spectroscopy system 1012.

Metering system 1000 may be used to meter the addition of product 1008 to product 1002 in line 1004 based on measurements taken by FSO spectroscopy system 1012. For example, if FSO spectroscopy system 1012 analyzes the fluid flowing through line 1004 and determines that the composition of said material is such that the concentration of product 1008 is below an acceptable range, control system 1014 may be configured to control valve 1010 such that valve 1010 permits an increased flow of product 1008 into line 1004. Conversely, if the analysis performed by FSO spectroscopy system 1012 shows that the concentration of product 1008 is higher than that of the acceptable range, control system 1014 may be configured to control valve 1010 to restrict the flow of product 1008 into line 1004.

Such systems may allow for near-real-time control and correction of metering, which may in turn result in more accurate metering, which provides for a number of benefits including but not limited to more consistent product mixes, greater product yields, less waste due to improper mixing of products, etc.

Another potential use case for the FSO spectroscopy systems discussed herein is that of the analysis of the compositions of gases being released during the flaring process of oil and gas production. Spectrometers are used to analyze gases in oil and gas flaring by measuring the emitted light from the combustion process to determine the composition and concentration of various gases. In some setups, spectrometers measure the absorption of light as it passes through the gas plume above the flare. Different gases absorb light at specific wavelengths, and by analyzing the absorption spectra, the spectrometer can determine the concentration of gases like CO₂, CH₄, and other volatile organic compounds (VOCs) in the flare emissions and determine its net heating value based thereon.

Some spectrometers, such as the hardened FSO spectroscopy systems taught herein, which are enclosed in explosion resistant enclosures, can be used in remote sensing applications to monitor flaring from a distance. This allows for continuous monitoring of gas emissions without direct contact with the flare, providing real-time data on the environmental impact and efficiency of the flaring process. Additionally, such hardened FSO spectroscopy systems may help in ensuring that flaring activities comply with environmental regulations by accurately measuring pollutant levels and emissions. This data is critical for minimizing the release of harmful gases into the atmosphere and for reporting to regulatory agencies.

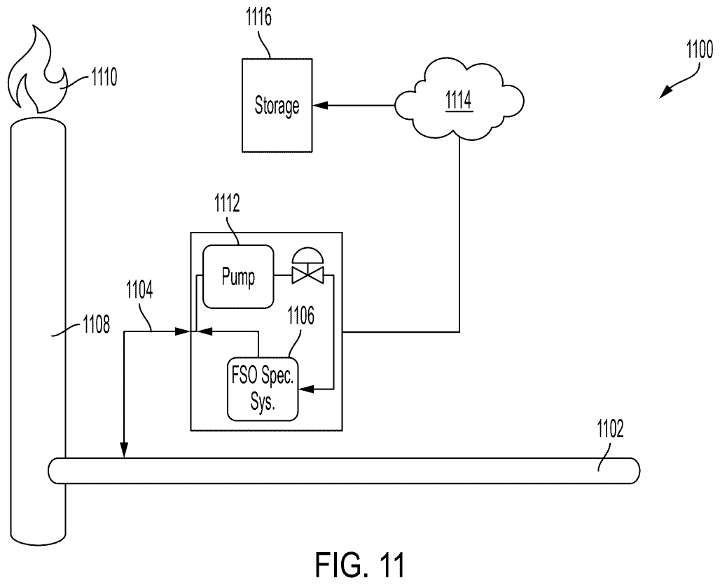

FIG. 11 shows a block diagram of an exemplary system for flare monitoring using an FSO spectroscopy system, namely flare monitoring system 1100. In flare monitoring system 1100 sample pump 1112 may be connected to flare duct 1102 via line 1104 such that it may extract a portion of the fluid flowing through duct 1102 and provide it to FSO spectroscopy system 1106. FSO Spectroscopy system 1106 may receive sample fluid from line 1104 and perform analysis on it in near real time. Line 1104 may comprise an extraction line and a return line. One or more of the extraction line and the return line may be heated. Once FSO spectroscopy system 1106 has analyzed the fluid sample, the fluid sample may be returned to duct 1102 via the return line portion of line 1104. After being returned to flare duct 1102 the sample fluid may be transported to flare stack 1108 through which it may travel before being burned as part of flare 1110.

Once FSO spectroscopy system 1106 has performed an analysis of the fluid sample, the results of the analysis may be recorded. The information captured by FSO spectroscopy system 1106 may be transmitted to a remote storage location via a suitable means of communications 1114 (e.g., cellular network, Wi-Fi, wired connection, etc.). Said information may be used to help complete EPA mandated test reports related to the flaring operation into which flare monitoring system 1100 is integrated.

Another potential use case for systems incorporating FSO spectroscopy systems, such as those contemplated hereby, is that of corroboration/validation of materials exchanged during a transfer of custody.

When one party is receiving a pipeline product from another party it would be beneficial for both of said parties to have a means of corroborating and/or validating the transfer. Accordingly, systems incorporating FSO spectroscopy systems may be used to analyze the composition of the material being so transferred in near real time.

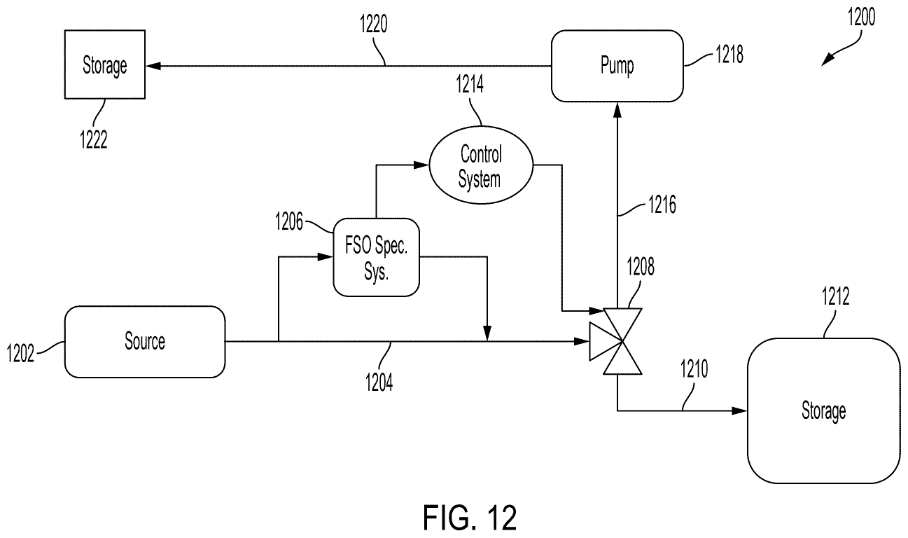

FIG. 12 shows a block diagram of an exemplary system for custody transfer monitoring using an FSO spectroscopy system, namely custody transfer system 1200. Custody transfer system 1200 may comprise fluid source 1202 which may be connected to valve 1208 via supply line 1204. FSO spectroscopy system 1206 may be connected to supply line 1204 before it reaches valve 1208. Valve 1208 may be connected to storage container 1212 via supply line 1210. Valve 1208 may also be connected to source 1202 via recirculation line 1216. Control system 1214 may be communicably connected to each of FSO spectroscopy system 1206 and valve 1208 and may be configured to control valve 1208 such that it may reversibly permit and/or restrict the flow of fluid from supply line 1204 to one or more of supply line 1210 and recirculation line 1216 responsive to determinations made by FSO spectroscopy system 1206.

FSO spectroscopy system 1206 may be configured to receive a sample of the fluid in supply line 1204 and to perform a spectroscopic analysis of said sample. After analysis of the sample by FSO spectroscopy system 1206, the sample may be returned to supply line 1204. The results of the analysis of the sample by FSO spectroscopy system 1206 may be communicated to control system 1214 which may determine how to control valve 1208 based on the analysis.

If the analysis performed by FSO spectroscopy system 1206 indicates that the fluid flowing through supply line 1204 is within acceptable parameters, it may control valve 1208 such that valve 1208 permits said fluid to flow from supply line 1204 to supply line 1210 and into storage container 1212. On the other hand, if the analysis performed by FSO spectroscopy system 1206 indicates that the fluid flowing through supply line 1204 falls outside of acceptable parameters, control system 1214 may control valve 1208 such that valve 1208 restricts the flow of fluid from supply line 1204 to supply line 1210, and redirects the flow of the fluid from supply line 1204 to recirculation line 1216 such that it may be recovered at source 1202 rather than tainting the composition of the fluid being received at storage container 1212.

When FSO spectroscopy system 1206 determines that the fluid flowing through supply line 1204 is again within acceptable parameters, control system 1214 may control valve 1208 to reconnect supply line 1204 to supply line 1210 in order to establish the flow of fluid therebetween, and to restrict the flow of fluid from supply line 1204 to recirculation line 1216.

In embodiments, recirculation line 1216 may be connected to pump 1218 which may be configured to enable fluid determined by FSO spectroscopy system 1206 to be outside of acceptable parameters to be redirected from storage 1212 and instead to flow through recirculation lines 1216 and 1220 and pumped into storage 1222 which may be used to retain fluid so rejected.

In embodiments, control system 1214 may record information related to the actions performed by custody transfer system 1200, which may be used as a means of corroborating or otherwise validating the transfer performed by the system.

Another potential use case for systems incorporating FSO spectroscopy systems include those related to the stabilization of the vapor point of raw and/or crude pipeline products.

Raw, unstabilized crudes, condensates, and blends can be dangerous to store and transport due to high vapor pressure. Therefore, stabilizing is now often required to ensure the product meets safety specifications, usually measured by vapor pressure. Measuring the vapor pressure of stabilized crude, stabilized condensate, and condensate blends in midstream facilities has proven to be a challenge due to paraffins in the process stream. Analysis with a conventional American Society for Testing and Materials (ASTM) method requires the sample to be measured at 100° F., which is below the condensing point of paraffin present in the typical condensate stream. This plugs sample lines and measurement cells in a traditional on-line Reid vapor pressure (RVP) analyzer, which leads to a maintenance-intensive failure of the device.

On-line systems utilizing conventional ASTM methods are mechanical devices with cycle times between 4-6 minutes, not including sample lag. Due to the slow response, real-time control of the stabilizer is not possible. Manual control necessitates “overcooking” the condensate, which increases vapor pressure give-away into low-value gas product and wastes fuel.

A typical RVP analyzer requires a sample conditioning system (SCS), and spent sample is flared or vented. These sampling and analytical operations, therefore, negatively impact the environmental, social, and governance (ESG) profile of a site by increasing hydrocarbon emissions and its carbon footprint.

FSO spectroscopy systems can operate at higher sampling rates, while the samples that they are analyzing remain at line temperatures and pressures, and without the need for a sampling system, sample lines, or filtering.

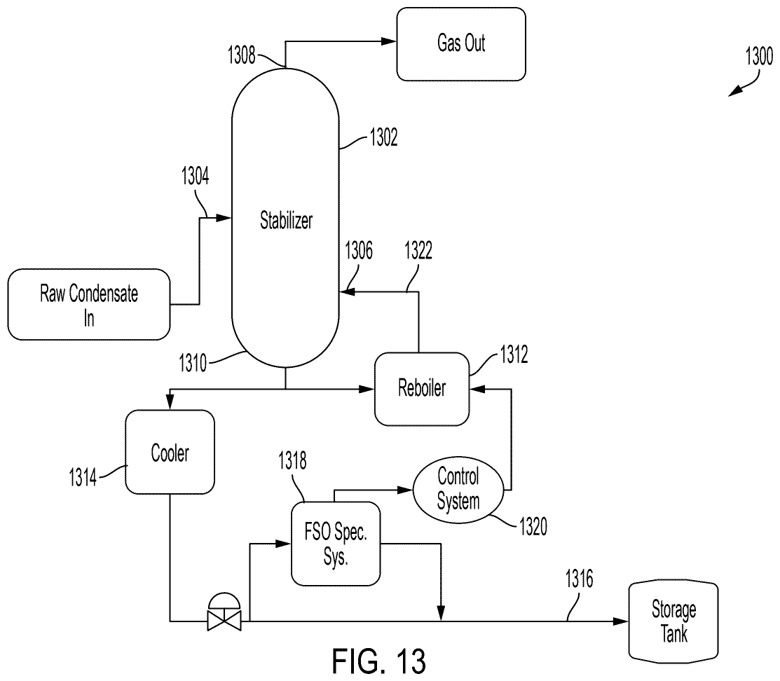

FIG. 13 shows a block diagram of an exemplary system for vapor pressure stabilization of pipeline products using an FSO spectroscopy system; namely, stabilization system 1300. Stabilization system 1300 may comprise vessel 1302, which may comprise inlets 1304 and 1306 and outlets 1308 and 1310. Vessel 1302 may be in fluid communication with reboiler 1312 and cooler 1314 via outlet 1310 (and in the case of reboiler 1312, by inlet 1306 and resupply line 1322). FSO spectroscopy system 1318 may be in fluid communication with output line 1316 such that FSO spectroscopy system 1318 may receive and perform spectroscopic analysis on samples from output line 1316 in near real time. Control system 1320 may be communicably connected to each of FSO spectroscopy system 1318 and reboiler 1312. The results of the analysis performed by FSO spectroscopy system 1318 may be communicated to control system 1320, which may use the results of said analysis to control reboiler 1312.

Vessel 1302 may receive fluid to be processed via inlet 1304. Reboiler 1312 may heat vessel 1302 such that components of the fluid in vessel 1302 having higher vapor pressures may be converted to a gaseous state. Such gases may exit vessel 1302 via outlet 1308. The remaining fluid in vessel 1302 (consisting mainly of the remaining materials having comparatively lower vapor pressures) may exit vessel 1302 via outlet 1310, where they may be supplied to one of reboiler 1312 or cooler 1314. The material supplied to reboiler 1312 may be heated by reboiler 1312 and reintroduced into vessel 1302 via resupply line 1322. The material so supplied to cooler 1314 may be cooled by cooler 1314 and then output therefrom via output line 1316.

Control system 1320 may be configured such that it may control reboiler 1312, based on the analysis being performed on the fluid flowing through output line 1316 by FSO spectroscopy system 1318. For example, if FSO spectroscopy system 1318 determines that the composition or the physical properties (e.g., the RVP) of said fluid falls outside of acceptable parameters, control system 1320 may increase or decrease the temperature of reboiler 1312 in order to meet product specifications.

Measuring condensate RVP in real-time allows condensate stabilizer operators to maintain a product stream closer to specification by more precisely controlling the heater operation. Allowing lighter hydrocarbons to remain in the product via reduced heating both increases liquid volume and reduces fuel gas consumption. Operators of condensate stabilizers will find a minimum of product give-away and energy consumption and a maximum of product volume and profitability by producing condensate close to the maximum RVP specification without exceeding it.

In embodiments, the fluids that FSO spectroscopy systems may be used to analyze include pipeline products, which may comprise one or more hydrocarbon fluids, including but not limited to: refined petroleum products, crude petroleum products, natural gas liquids, and natural gases. Therefore, systems using FSO spectroscopy systems may be utilized in the identification and separation of in-line pipeline products.

Pipelines are often used to transport multiple types of products in a batch mode, where one product follows another. In industrial pipelines, especially those used for transporting multiple products such as oil, gas, refined fuels, chemicals, or even food products, separating inline pipeline products is essential to prevent contamination, maintain product quality, and ensure operational efficiency.

When different products are transported in the same pipeline, mixing or cross-contamination can occur if they are not properly separated. For instance, in pipelines transporting oil products like gasoline, diesel, and jet fuel, any mixing between them can render large quantities of the product unusable or require expensive reprocessing. Effectively separating inline products reduces operational costs, as it minimizes waste and the need for additional treatments or handling and helps ensure that the final products meet required specifications, as well as safety and quality standards.

In embodiments systems incorporating FSO spectrometry systems may comprise a sensor capable of obtaining spectra information from the product(s) flowing through a pipeline in situ while undergoing continuous flow and in near-real-time. This may allow for more rapid and accurate detection and routing of transmixes.

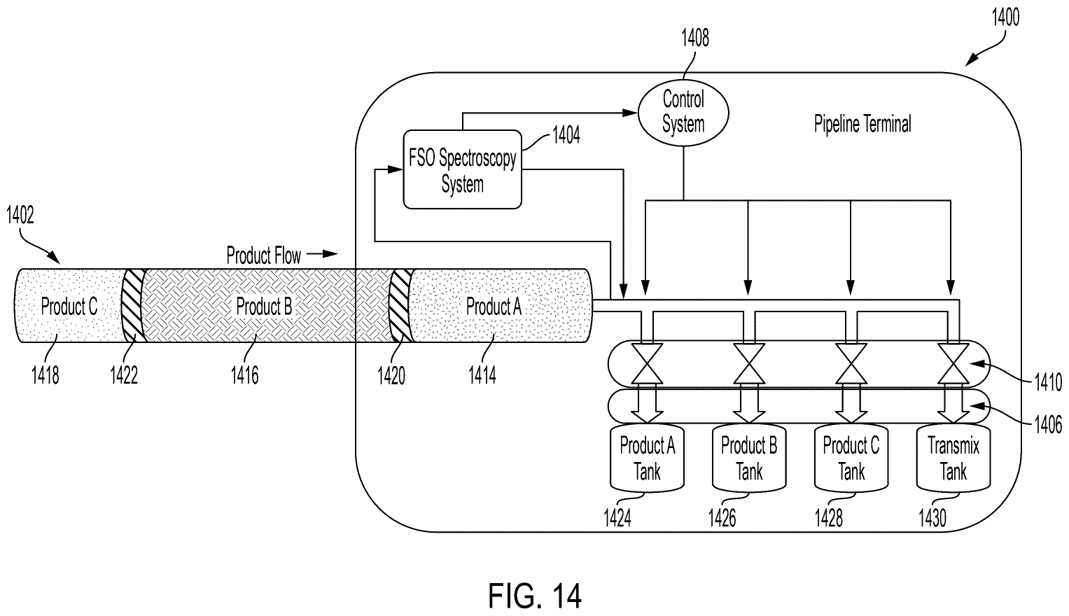

FIG. 14 shows a block diagram of an exemplary system for transmix separation using an FSO spectroscopy system; namely transmix separation system 1400. Transmix separation system 1400 may comprise line 1402 to which FSO spectroscopy system 1404 may be in fluid communication. FSO spectroscopy system 1404 may be in communication with control system 1408. FSO spectroscopy system 1404 may be configured to perform a spectroscopic analysis of a sample of fluid flowing through line 1402 in near real time and may transmit the results of said analysis to control system 1408.

Transmix separation system 1400 may comprise one or more outlets 1406, each of which may be in fluid communication with, and separated by a valve 1410 from, line 1402. Control system 1408 may be configured to control each valve 1410 such that they may reversibly permit or restrict the flow of fluid from line 1402 to and through its corresponding outlet 1406. Control system 1408 may be programmed to control one or more valve 1410 responsive to the information it receives from FSO spectroscopy system 1404. Control system 1408 may control each such valve 1410 independently of one another.

In embodiments, each valve 1410 and outlet 1406 may correspond to a different product.

In embodiments, the fluid flowing through line 1402 may comprise a plurality of products, such as product A 1414, product B 1416, and product C 1418. The mixing of such products may occur at interfaces where they meet in the pipeline, such as at interface 1420 between product A 1414 and product B 1416, and interface 1422 between product B 1416 and product C 1418. The mix of products at such interfaces may not be suitable for downstream uses and therefore may have to be directed into transmix (a.k.a. “slop”) tanks. To facilitate this, FSO spectroscopy system 1404 may analyze the fluid traveling through line 1402 in near real-time in order to determine its composition. If, for example, FSO spectroscopy system 1404 detects product A 1414, based on that determination control system 1408 may open the valve associated with the outlet line 1412 associated with product A 1414, and close all other valves 1410; thereby enabling product A 1414 to flow through said valve and out of line 1402 via the appropriate outlet 1406 associated with said product A 1414, and into its corresponding receptacle, such as product A tank 1424. When FSO spectroscopy system 1404 detects that the composition of product A 1414 starts changing to that of product B 1416 (identified as interface 1420), control system 1408 may respond by, for example, controlling the valves 1410 such that only the valve corresponding to an outlet 1406 associated with a transmix is opened; thereby enabling the transmix at interface 1420 to flow through said valve and out of line 1402 via the appropriate outlet 1406 associated with said transmix, which in the embodiment depicted allows the transmix to flow into transmix tank 1430.

Similarly, when FSO spectroscopy system 1404 determines that the composition of the fluid flowing through line 1402 is within predetermined acceptable parameters for product B 1416 (i.e., no longer containing a sufficient level of product A 1414 to be considered a transmix), control system 1408 may use such a determination to control valves 1410 such that the valve corresponding to the outlet line 1412 associated with product B 1416 is open, and all other valves 1410 are closed; thereby enabling product B 1416 to flow through said valve and out of line 1402 via the appropriate outlet 1406 associated with said product B 1416, and into its corresponding receptacle, such as product B tank 1426.

Such a process of analysis and control may be performed iteratively as may be necessary to process such mixed inline products. For example, the process may be used in a similar manner to separate product B 1416 and product C 1418, and to remove the transmix formed between product B 1416 and product C 1418, located at interface 1422. Product C 1418 may be sent to product C tank 1428, while the transmix between product B 1416 and product C 1418 may be sent to either transmix tank 1430 or another suitable receptacle.

The products at the interfaces between different pipeline products, such as interfaces 1420 and 1422, may, after being separated out, be recaptured and processed, downgraded, and/or disposed of in an appropriate manner.

In embodiments, the datapoints representing spectra information from samples of product flowing through a pipeline may be projected in a cartesian space configured such that the proximity of datapoints reflects a similarity in the respective samples' spectra information. In such embodiments, once projected, a distance metric may be utilized to distinguish stable versus changing spectra, and therefore stable pipeline products versus transmixes. Datapoints which are clustered are deemed to be stable and datapoints which are projected further away from a cluster indicate that the product flowing through the pipeline has changing spectral characteristics from the stable products and may be labeled as a transmix.

While the present system and method have been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, may be combinable into aggregate embodiments. The terms “a”, “an”, and “the” mean “one or more” unless expressly specified otherwise. The term “connected” means “communicatively connected” or “operatively connected” unless explicitly defined otherwise in a specific instance.

To aid the Patent Office and any readers of any patent issued on this application in interpreting the claims appended hereto, the applicant wishes to note that it does not intend any of the claims or claim elements presented in this application to invoke 35 U.S.C. 112(f) unless the words “means for” or “step for” are explicitly used in the particular claim.

1. A free space optical spectrometer system comprising:
a laser module configured to output a laser beam that scans across a range of wavelengths;
a beam splitter configured to receive the laser beam and split the laser beam into a plurality of daughter beams;
a flow cell positioned along a path of a first daughter beam, the flow cell configured to contain a sample fluid and permit transmission of the first daughter beam therethrough to a first detector;
a reference cell positioned along a path of a second daughter beam, the reference cell configured to contain a reference fluid and permit the transmission of the second daughter beam therethrough to a second detector;
an etalon positioned along a path of a third daughter beam to produce a reference interference pattern, the third daughter beam being received thereafter by a third detector;
a fourth detector positioned to directly receive a fourth daughter beam transmitted only through free space; and
an analog-to-digital converter configured to receive electrical signals from each of the first, second, third and fourth detectors and to determine corresponding absorption spectra therefrom.

2. The free space optical spectrometer system of claim 1, further comprising a reflector positioned across the flow cell, opposite the laser module, and wherein the first daughter beam reflects off of the reflector after having passed through the flow cell and before being received by the first detector.

3. The free space optical spectrometer system of claim 2, wherein the first detector and the laser module are positioned on the same side of the reference cell relative to the reflector and are housed within the same enclosure.

4. The free space optical spectrometer system of claim 1, wherein said spectrometer system is configured to determine a first spectrum from the first detector, a second spectrum from the second detector, a third spectrum from the third detector, and a fourth spectrum from the fourth detector; and to correct the first spectrum based on one or more of the second, third, and fourth spectra.

5. The free space optical spectrometer system of claim 4, wherein the correction of the first spectrum comprises:
applying dark current corrections to signals from each detector;
calculating a wavelength offset by comparing the second spectrum to a known reference spectrum of the reference fluid;
determining a wavelength correction function by flattening the third spectrum;
generating a corrected signal absorption spectra using the dark-current corrected and wavelength-corrected spectra.

6. A method for wavelength correction in a free space optical spectrometer system comprising the steps of:
generating a laser beam that scans across a range of wavelengths;
splitting the laser beam into a plurality of beams using a beam splitter;
determining a sample spectrum from a first beam after it has passed through a sample fluid;
determining a reference-free-space spectrum from a second beam after it has passed through only free space;
determining a reference-cell spectrum from a third beam after it has passed through a reference material contained in a reference cell;
determining an etalon spectrum from a fourth beam after it has passed through an etalon;
performing dark current corrections on each of the spectra obtained from the first, second, third and fourth beams;
calculating a wavelength offset between the reference-cell spectrum and a known spectrum for the reference material;
determining a wavelength correction equation by flattening the etalon spectrum;
performing wavelength correction on each of the dark current corrected spectra based on the wavelength offset and the wavelength correction equation; and
determining a signal absorption spectrum for the sample spectrum based on the wavelength-corrected sample spectrum and the wavelength-corrected reference-free-space spectrum.

7. The method of claim 6 further comprising the step of:
determining a concentration of a component of the sample fluid by applying a chemometric model to the signal absorption spectrum.

8. The method of claim 6 further comprising the step of:
applying a chemometric model for the reference material to the dark-current-corrected reference-cell spectrum to determine a wavelength calibration of the spectrometer; and
correcting the signal absorption spectrum based on the wavelength calibration.

9. The method of claim 6 wherein the range of wavelengths consists of from approximately 1,590 nm to approximately 1,800 nm.

10. A engine system comprising:
a first control valve positioned along a first supply line in fluid communication between a first fuel supply and a fuel input of an engine, the first control valve being configured to regulate a flow of a first fuel from the first fuel supply to the fuel input;
a second control valve positioned along a second supply line in fluid communication between a second fuel supply and the fuel input, of the engine, the second control valve being configured to regulate a flow of a second fuel from the second fuel supply to the fuel input;
a free-space optical spectrometer in fluid communication with the first supply line at a location between the first fuel supply and the first control valve, the spectrometer being configured to obtain spectroscopic measurements of the first fuel in near real time; and
a control system operatively coupled to the spectrometer and to the first and second control valves, the control system being configured to determine one or more characteristics of the first fuel based on the spectroscopic measurements and to control actuation of at least one of the first control valve or the second control valve responsive to said determination.

11. A method of operating an engine comprising the steps of:
flowing a first fuel to an engine;
spectroscopically monitoring a characteristic of the first fuel;
determining if the characteristic is outside of a predetermined parameter;
modulating the flow of the first fuel to the engine based on said determination; and
modulating a flow of a second fuel to the engine.

12. The method of claim 11, wherein the step of spectroscopically monitoring a characteristic of the first fuel is performed in situ using a free-space optical spectrometer while the first fuel is flowing to the engine.

13. The method of claim 11, wherein the first fuel comprises a field gas, and the second fuel comprises a fuel having known combustion characteristics.

14. The method of claim 11, wherein the characteristic comprises one or more of:
an octane value;
a heating value; and
an amount of a contaminate.

15. The method of claim 11, wherein the steps of modulating the flows of the first and second fuels to the engine comprise one or more of:
reducing the flow of the first fuel to the engine, and
increasing the flow of the second fuel to the engine; and
increasing the flow of the first fuel to the engine, and
reducing the flow of the second fuel to the engine.
